(19) United States
(12) Patent Application Publication
(10) Pub. No.: US 2006/0145030 A1
(43) Pub. Date: Jul. 6, 2006

(54) Deformation-control system and method

(76) Inventors: David L. Cowan, Lakewood, CA (US); John Zebulon Tidwell, Long Beach, CA (US)

Correspondence Address: c/o Gerald Andersen, Ste 400, 2780 Skypark Drive, Torrance, CA, 90505, US

(21) Appl. No.: 11/007,733

(22) Filed: Dec. 7, 2004

(51) Int. Cl. B64C 3/44

(52) U.S. Cl. 244/219

(57) ABSTRACT

A system for selectively controlling deformation. The system includes a first mechanism for resisting deformation about an axis of an accompanying fluid foil. A second mechanism, in communication with the first mechanism, enables deformation along the axis and/or at an angle to the axis. In more a specific embodiment, the axis is a lengthwise axis of the fluid foil, which is a transformable airfoil, and the system includes a bellows device that is approximately concentric with the axis. The bellows device is supported by first base structure at one end and a second base structure at another end. The deformation at an angle to the first axis includes shear deformation or bending deformation. The deformation along the axis includes extension or strain deformation. The deformation about the axis includes torsion deformation.

This invention was made with Government support under Defense Advanced Research Projects Agency (DARPA) Contract No. F33615-02-C-3257. The Government may have certain rights in this invention.

### BACKGROUND OF THE INVENTION

1. Field of Invention

This invention relates to structural supports. Specifically, the present invention relates to systems and methods for selectively resisting deformation of a structure or device, such as a transformable wing.

2. Description of the Related Art

Systems for selectively resisting deformation are employed in various demanding applications including automotive shocks, building reinforcements, and aircraft airfoils. Such applications may demand versatile support structures that can resist deformation in one dimension but allow deformation or translation in another.

Versatile support structures are particularly important in transformable wing applications, where support structures must often allow movement in one dimension but resist in another. Transformable wings may include a moveable frame or bladder surrounded by a mechanically compliant skin. The wings must often withstand large aerodynamic loads in various shape configurations. Large aerodynamic loads are particularly prevalent in high G-force applications, such as jet-wing or missile-fm applications.

Design constraints of conventional transformable wings limit structural capabilities, such as torsional rigidity, i.e., resistance to twisting. Torsional rigidity is required for optimum wing stability, including static aeroelastic and flutter stability. Conventional transformable wings typically lack mechanisms to efficiently minimize torsion. Accordingly, they may exhibit excessive twisting in response to large aerodynamic loads, which often occur during high speed flight.

Hence, a need exists in the art for a system and method for enhancing torsional rigidity of a transformable fluid foil, such as a morphing aircraft wing. There exists a further need for a transformable fluid foil that incorporates the system for enhancing torsional rigidity.

### SUMMARY OF THE INVENTION

The need in the art is addressed by the system for selectively controlling deformation of the present invention. In the illustrative embodiment, the inventive system is adapted for use with transformable foils, such as morphing wings. The system includes a first mechanism for resisting deformation about an axis of an accompanying fluid foil. A second mechanism employs the first mechanism and enables deformation along the axis and/or at an angle to the axis.

In a specific embodiment, the axis is a lengthwise axis, i.e., span axis, of the fluid foil, which is a transformable airfoil. The first mechanism resists torsion about the axis, and second mechanism enables shear deformation. The first and second mechanisms employ a bellows device that is approximately concentric with the lengthwise axis. The bellows device is supported by first and second base structures at opposite ends of the bellows device. The deformation at an angle to the first axis includes shear deformation or bending deformation. The deformation along the axis includes extension deformation. The deformation about the axis includes torsion deformation.

In an illustrative embodiment, the system includes a box wherein the bellows device is positioned. The box includes four pivotally connected sides. In the illustrative embodiment, the second mechanism fturther includes a controller for controlling deformation of the bellows device via one or more actuators that are responsive to control signals from the controller. A fourth mechanism selectively allows shear deformation and inhibits torsion deformation in response to signals from the controller. The fourth mechanism may be implemented via one or more support connectors that are pivotally connectable between one or more of the pivotally connected sides.

In another illustrative embodiment, the airfoil includes a frame having one or more adjustable spars connected to one or more adjustable ribs and a deformable surface substantially covering the frame or a portion thereof The spars and ribs are interconnected so that selectively expanding or contracting a cord of the airfoil automatically sweeps the airfoil back or forward.

The novel design of one embodiment of the present invention is facilitated by use of a bellows device as a support structure for a transformable airfoil, such as a morphing wing. The bellows device effectively inhibits twisting about an axis of the device while enabling extension and shear deformation. Accordingly, the bellows device may greatly enhance transformable-airfoil performance by selectively resisting torsion deformation while enabling shear transformation.

### BRIEF DESCRIPTION OF THE DRAWINGS

FIG. 1 is a diagram of a deformable airfoil adapted to resist torsion according to an embodiment of the present invention.

FIG. 2 is a more detailed diagram of a deformation-control structure employed as a wing box in the deformable airfoil of FIG. 1.

FIG. 3 is a top view showing the deformation-control structure of FIG. 1 exhibiting no deformation.

FIG. 4 is atop view showing the deformation-control structure of FIG. 1 exhibiting shear deformation.

FIG. 5 is a diagram of an illustrative embodiment of the deformation-control structure of FIG. 1.

FIG. 6 is a more detailed diagram of a morphing airfoil adapted for use with the deformation-control structures of FIGS. 1 and 4.

FIG. 7 is a graph comparing torsional deflection of a box with and without the bellows structure of FIG. 1 for various applied moments.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

For the purposes of the present discussion, a fluid is any substance, gas, or beam of particles that flows, such as in response to application of a predetermined force, such as a force acting tangential to a surface of the fluid. Accordingly, air, water, and solar plasma are all considered fluids.

A fluid foil is any surface designed to manipulate fluid flow. Fluid foils include boat motor propellers, boat sails, solar sails for spacecraft applications, cement mixer blades, and airfoils, such as missile-steering fms and aircraft wings. An airfoil is a fluid foil that is adapted to manipulate airflow.

A deformable skin is a covering with an outer shape and/or surface area that may adapt to accommodate geometrical changes in a structure that supports and/or is covered by the skin. Consequently, sliding skins and various flexible skins, such as elastomeric skins, are considered deformable skins.

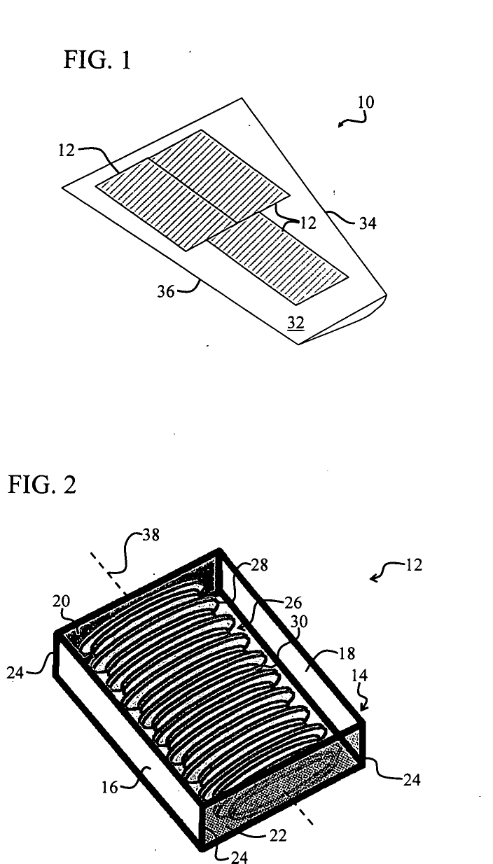

FIG. 1 is a diagram of a deformable airfoil 10 adapted to resist torsion according to an embodiment of the present invention. The deformable airfoil 10 may be implemented as a transformable wing, vertical stabilizer, horizontal stabilizer, missile-steering fin, boat rudder, and so on, without departing from the scope of the present invention. For clarity, various features, such as power supplies, control levers, and son on, have been omitted from the figures. However, those skilled in the art with access to the present teachings will know which components and features to implement and how to implement them to meet the needs of a given application.

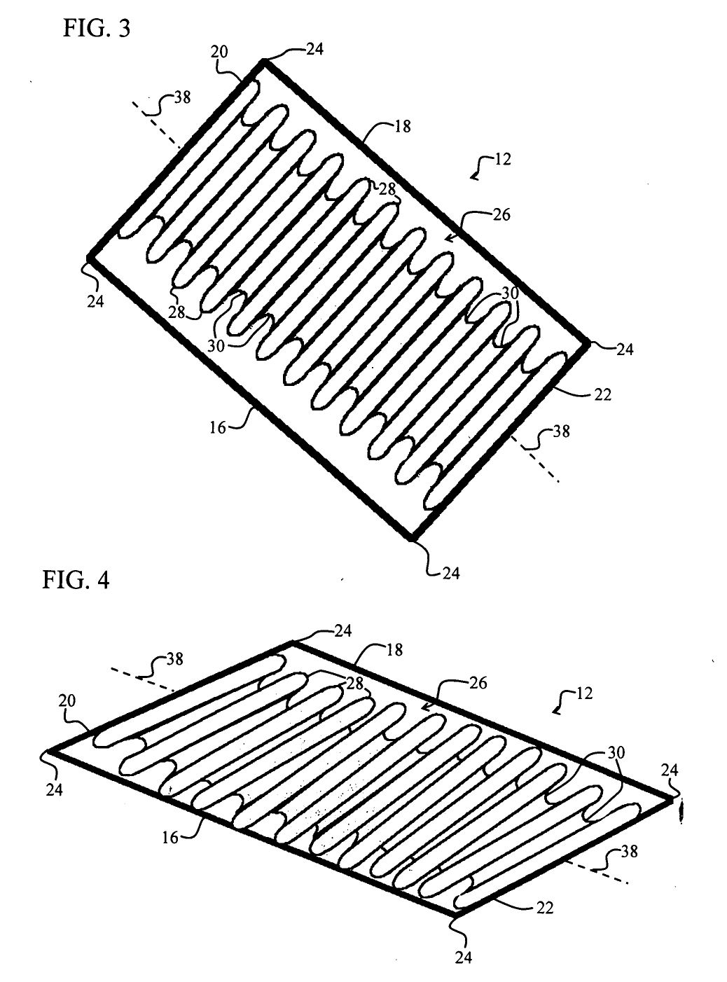

FIG. 2 is a more detailed diagram of a deformation-control structure 12 employed as a wing box in the deformable airfoil 10 of FIG. 1. With reference to FIGS. 1 and 2, a bottom schematic view of the deformable airfoil 10 is shown having three wing box deformation-control structures 12 mounted therein or thereto. In the present specific embodiment, each deformation-control structure 12 has four sides 16-22, which are pivotally interconnected. The four sides include a left side panel 16, a right side panel 18, a first base panel 20, and a second base panel 22. The four side panels 16-22 are interconnected via hinges 24. A bellows device 26 having convolutions comprising large-radius sections 28 and small-radius sections 30 is positioned within the region formed by the four side panels 16-22. One base end of the bellows device 26 is fixed to the first base panel 20, while the opposite base end of the bellows device 26 is fixed to the second base panel 22.

In the present embodiment, the side panels 16, 18 are made to pivot or rotate relative to the base panels, 20, 22 via the hinges 24. The base panels 20, 22, which may be constructed from a suitable metal, are rigid to provide support for the bellows device 26 and to the facilitate mounting the bellows device 26 within the transformable airfoil 10. The base panels 20 are secured to both the bellows device 26 and the airfoil 34 or a frame thereof so that deformation properties of the deformation-control structure 34 affect deformation properties of the air foil 10.

The side panels 16, 18, are likewise constructed of a suitable metal to enable substantial forces to be transferred between the base panels 20, 22. Flexible or rigid top and bottom panels (not shown) or flexible side panels may be employed without departing from the scope of the present invention. The various panels 16-22 implement a wing box structure for enhancing wing structural integrity.

The deformation-control structures 12 of FIG. 1 are fitted together so that the respective hinges 24 are not constrained by adjacent box structures. Accordingly, the entire assembly of the three deformation-control structures 12 may selectively exhibit elastic shear deformation while resisting torsion. Accordingly, the deformable wing 10 resists torsion but enables sweep adjustments, which corresponds to shear deformation. Furthermore, the deformation-control structure 12, and particularly, the bellows device 26 may enable bending deformation about the longitudinal axis 38 in addition to shear deformation. To allow bending deformation, the hinges 24 are implemented via hinges that allow rotation of the side panels 16, 18 relative to the base panels 20, 22 in both vertical and horizontal planes.

Alternatively, one could construct a wing box that would also allow axial strain deformation. The bellows device 26 would permit strain deformation while still providing torsional rigidity. In one such embodiment, the side panels 16, 18 are made from flexible material or from another material or structure that is capable of exhibiting strain deformation. For example, the side panels, 16, 18 could be telescoping as discussed more fully below.

Those skilled in the art will appreciate that deformation-control structures 12 may be removed, or additional structures may be added to the airfoil 10, or the structures 12 may be replaced with a single box structure or a deformation-control structure with a different shape and/or size without departing from the scope of the present invention.

In operation, the bellows device 26 is compressible, having sides that may collapse, thereby causing the centers of the large-radius sections 28 and small-radius sections 30 to move closer together. However, the bellows device 26 resists twisting moments about a longitudinal axis 38. Accordingly, the entire deformation-control structure 12 will deform in bending to yield an “S” shape when subjected to applied shear loads at the base structures 20, 22. However, the bellows device 26 exhibits great rigidity under the presence of a torsion moment applied at both base structures 20,22.

The bellows device 26 may be implemented via a metallic structure having sidewalls with spring-shaped or S-shaped cross-sectional profiles. The exact choice of materials and the spring constant of the sidewalls of the bellows device 26 are application specific and may be determined by those skilled in the art to meet the needs of a given application without undue experimentation. Methods for fabricating convoluted tubes are known in the art and may be readily adapted by those skilled in the art to fabricate the bellows device 26 without undue experimentation.

In the present specific embodiment, the bellows device 26 is constructed from fiber-reinforced composite to allow its stiffness properties to be directionally tailored. The exact choice of material is application-specific. For example, steel, graphite composite, alloys, or other metals may be employed to meet the needs of a given application.

The bellows device 26 may exhibit a circular, elliptical, or other cross-sectional shape. In the present specific embodiment, the bellows device 26 has an elliptical cross-sectional shape. The bellows device 26 may also have an asymmetrical cross-sectional shape to facilitate inhibiting torsion deformation. An elliptical cross-sectional shape is particularly effective in inhibiting torsion deformation in an alternative embodiment (not shown), wherein the bellows device 26 is implemented via telescoping segments.

FIG. 3 is a top view showing the deformation-control structure 12 of FIG. 1 exhibiting no deformation. The side panels 16, 18 are not sheared or rotated, and the bellows device 26 is not subjected to bending. When subjected to a shearing stress, the springs formed by the sidewalls of the bellow structure 26 selectively deform such that various large-radius sections 28 move closer to their adjacent neighbors in the compression regions and separate in the tension regions.

The cross-sectional shapes of the small-radius sections 30 and the large-radius sections 28 may be altered without departing from the scope of the present invention. For example, instead of exhibiting curved or S-shaped profiles, as shown in FIG. 3, the sections 28, 30 may exhibit triangular or M-shaped profiles.

During shear deformation, the longitudinal axis 38 is angled relative to its initial position. Accordingly, shear deformation may be considered deformation at an angle relative to the longitudinal axis 38 of the bellows device 26. Torsion deformation may be considered deformation in rotation about the longitudinal axis 38. Similarly, strain deformation, also called extension deformation, may be considered deformation along the longitudinal axis 38.

In another alternative embodiment (not shown), the deformation-control structure 12 and accompanying bellows device 26 has a progressively narrowing outside diameter that conforms to the shape of an accompanying deformable wing 10. In this embodiment, one large partially flattened bellows structure with a cross-sectional shape corresponding to the cross-sectional shape of the wing 10 of FIG. 1 is fitted into the deformable wing 10. In this embodiment, the base ends 20, 22 are implemented via tip and root ends of the wing 10, respectively.

FIG. 4 is a top view showing the deformation-control structure 12 of FIG. 1 exhibiting shear deformation. Different sides or portions thereof of the bellows device 26 may independently deform in bending, thereby enabling shear deformation of the deformation-control structure 12 in any direction. When the portions of the sidewalls of the bellows device 26 compress, the radius sections 28, 30 move closer together. When portions of the sidewalls of the bellows device 26 extend, the radius sections 28, 30 separate.

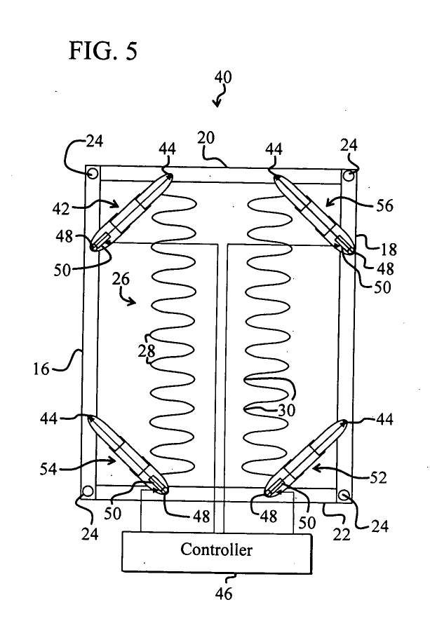

FIG. 5 is a diagram of an illustrative embodiment 40 of the deformation-control structure 12 of FIG. 1. The deformation-control structure 40 includes various telescoping rods, including an upper-left-corner telescoping connector 42, an upper-right-corner telescoping connector 56, a lower-left-corner telescoping connector 54, and a lower-right-corner telescoping connector 52. The upper-left-corner telescoping connector 42 is pivotally connected to the left side panel 16 and to the first base panel support structure 20. Similarly, the upper-right-corner telescoping connector 56 is pivotally connected between the first base panel support structure 20 and the right side panel 18. The lower-left-comer telescoping connector 54 and the lower-right-corner telescoping connector 52 are pivotally connected between the second base support structure 22 and the left side panel 16 and right side panel 18, respectively.

The various telescoping connectors 42, 52, 54, 56 selectively extend or contract in response to control signals from a controller 46. In the present illustrative embodiment, actuation of the telescoping connectors 42, 52, 54, 56 is coordinated to prevent the operation of one telescoping connector from interfering with the operation of another. In this embodiment, each of the telescoping connectors 42, 52, 54, 56 include a first pivot connector 48 at one end of the telescoping connectors 42, 52, 54, 56. Each of the telescoping connectors 42, 52, 54, 56 also include a second pivot connector 44 positioned opposite to the first pivot connector 48.

Any or all of the telescoping connectors 42, 52, 54, 56 may be omitted without departing from the scope of the present invention. Depending on the demands of a particular application, only one of the telescoping connectors 42, 52, 54, 56 may be required to selectively resist shear deformation by varying degrees.

In response to specific control signals from the controller 46, the telescoping connectors 42, 52, 54, 56 may hold or lock in any position in their range of motion, thereby inhibiting further shear deformation while holding the deformation-control structure 40 in a desired shape, i.e., configuration. The degree to which each of the telescoping connectors 42, 52, 54, 56 is extended determines the shape of the overall deformation-control structure 40. The telescoping connectors 42, 52, 54, 56 may selectively inhibit shear deformation within a plane containing the approximate centers of the telescoping connectors 42, 52, 54, 56.

In-plane shear of the structure 40 may be imparted or resisted depending on the commands, i.e., control signals received by the actuators 50 via the controller 46.

In a typical scenario, the controller 46 commands the telescoping of the actuators 50 via control signals. In an exemplary scenario, to impart desired shear deformation to the left, the upper left telescoping connector 42 and the lower right telescoping connector 52 are commanded by the controller 46 to contract, while the other telescoping connectors 54, 56 are commanded to expand.

Hence, the telescoping connectors 42, 52, 54, 56, accompanying actuators 50 and controller 46 facilitate controlling in-plane shear. The telescoping connectors 42, 52, 54, 56 selectively enable the deformation-control structure 40 to deform in shear and to resist deformation in shear to a desired degree in response to control signals received from the controller 46. For example, the controller 46 may issue commands to the actuators 50 to selectively adjust the degree to which the telescoping connectors 42, 52, 54, 56 resist extension and/or contraction, thereby affecting the degree to which the deformation-control structure 40 resists shear in one direction or another.

Alternatively, to allow strain deformation but inhibit shear deformation, the side panels 16, 18 may be made to telescope, i.e., extend or contract, and the telescoping connectors 42, 52, 54, 56 and accompanying actuators 50 may be positioned parallel to the axis of the deformation-control structure 40. The bellows device 26 would permit strain deformation by collapsing or expanding with the accompanying convolutions getting closer together or farther apart, respectively.

Systems and methods for locking telescoping rods and actuators in any given position are known in the art and may be adapted for use with the embodiments disclosed herein without undue experimentation. Exact implementation details of the telescoping connectors 42, 52, 54, 56 are application specific and may be adjusted to meet the needs of a given application.

In an alternative implementation (not shown), the telescoping connectors 42, 52, 54, 56 and accompanying controller 46 are omitted. Instead, various fixed elastic bands or rigid rods are manually positioned within the deformation-control structure 40 to selectively enable different types of deformation while enabling other types of deformation. For example, to inhibit torsion deformation and strain deformation but allow shear deformation, the telescoping connectors 42, 52, 54, 56 may be omitted. To resist shear by a predetermined amount, the telescoping connectors 42, 52, 54, 56 are replaced with appropriate tension bands. Alternatively, the pivot connectors 24 are replaced with variable-resistance pivot connectors or actuated pivot connectors.

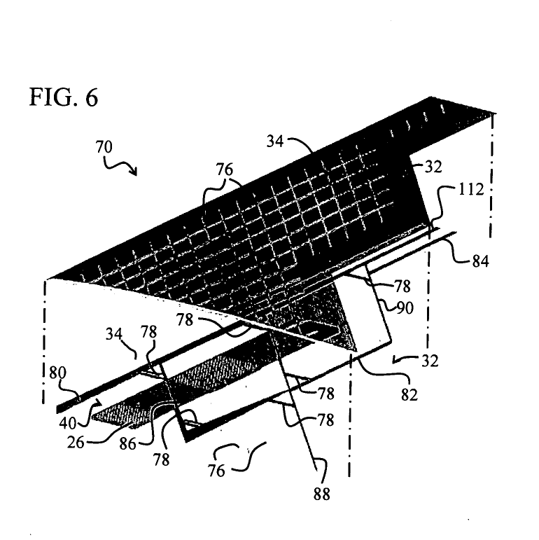

FIG. 6 is a more detailed diagram of a morphing aircraft airfoil 70 adapted for use with the deformation-control structures 12, 40 of FIGS. 1 and 4. The airfoil 70 includes a flexible skin 32, which may be a telescoping, elastomeric, another suitable deformable skin or covering. In the present embodiment, the airfoil 70 includes various adjustable spars 80, 82, 84, including a leading spar 80, a trailing spar 82, and a wingtip spar 84. Various adjustable ribs 86, 88, 90, including a first rib 86, a second rib 88, and a third rib 90 are pivotally interconnected to the spars 80, 82, 84. The adjustable ribs 86, 88, 90, and spars 80, 82, 84 form an adjustable frame that is sandwiched by the flexible skin 32, which is reinforced with crisscrossed stiffening rods 76. The adjustable ribs 86, 88, 90, and spars 80, 82, 84 are interconnected so that expansion or contraction of the base chord of the wing 70 automatically sweeps the leading edge 34 backward or forward. The deformation properties of the airfoil 70 reflect the deformation properties of the deformation control structure 40. Furthermore, actuation of the transformable airfoil 70 will cause corresponding actuation of the bellows device 26. In the present embodiment, the airfoil 70 may exhibit elastic shear transformation, thereby causing the bellows device to exhibit corresponding elastic shear deformation.

Deformation-control structures 26, which include partially flattened (elliptical) bellows structures 26, permit airfoil frame morphing but resist airfoil twisting. Various actuators 78 interconnect the ribs 86, 88, 90 and spars 80, 82, 84 and facilitate airfoil morphing, such as sweep-angle, area, wing span, and base chord length adjustments.

In the present embodiment, the flexible skin 32 is chosen to accommodate shear deformation yet enclose the airfoil 70 and support air pressure loads. The shear deformation of the airfoil 70 may minimize energy required to flex the skin 32, thereby reducing requisite sizes, strengths, and associated costs of the actuators 78.

The actuators 78 are chosen so that if they fail, they may telescope relatively free of resistance. Accordingly, if one of the actuators 78 fail, the airfoil 70 will not be frozen or locked in to position. Such actuators are well known and commercially available.

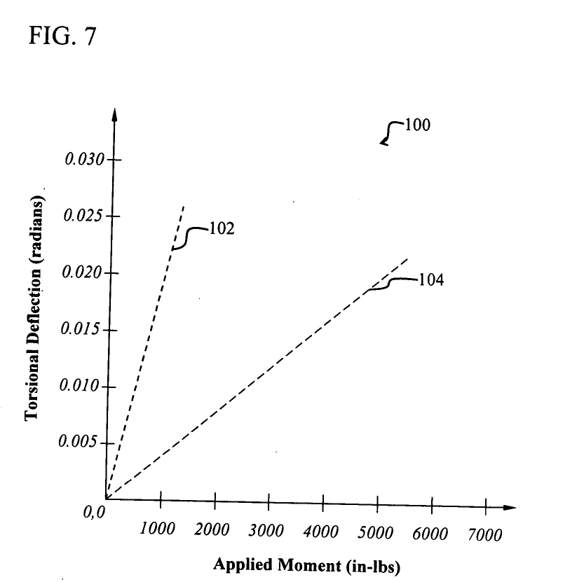

FIG. 7 is a graph 100 comparing torsional deflection (vertical axis) of a wing box having inelastic side panels with and without the bellows device 26 of FIG. 1 for various applied moments (horizontal axis). With reference to FIGS. 1 and 6, a wing box lacking the bellows device 26 deflects over 0.015 radians in response to an applied torsional moment of 1000 inch-pounds. A similar wing box fitted with the unique bellows device 26 exhibits less than 0.005 radians of deflection in response to an applied torsional moment of 100 inch-pounds. Accordingly, the bellows device 26 demonstrates several-fold improvement in torsional resistance when applied to a wing box structure.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

Accordingly,

What is claimed is:

1. A system for selectively controlling deformation of a fluid foil comprising:
first means for resisting deformation about an axis of said fluid foil and
second means for enabling deformation along said axis and/or at an angle to said axis, said second means employing said first means.

2. The system of claim 1 wherein said axis is a lengthwise axis of said fluid foil.

3. The system of claim 2 wherein said fluid foil is a transformable airfoil.

4. The system of claim 3 wherein said system includes a bellows device.

5. The system of claim 4 wherein said bellows device is approximately concentric with said axis, and wherein said bellows device is supported by a first base structure at one end and a second base structure at another end.

6. The system of claim 5 wherein said deformation at an angle to said first axis includes shear deformation or bending deformation; said deformation along said axis includes extension deformation; and wherein said deformation about said axis includes torsion deformation.

7. The system of claim 5 further including a box wherein said bellows device is positioned, said box having four pivotally connected sides said first base structure and said second base structure representing two of said pivotally connected sides.

8. The system of claim 7 wherein said second means includes third means for selectively inhibiting deformation at an angle to said axis, said third means including a controller.

9. The system of claim 8 wherein said deformation at an angle to said axis is shear deformation.

10. The system of claim 9 wherein said third means includes one or more support connectors pivotally connected between one or more of said pivotally connected sides.

11. The system of claim 9 wherein said wherein said one or more support connectors are telescoping connectors that extend from said first base structure to a left one of said pivotally connected sides, from said first base structure to a right one of said pivotally connected sides, from said second base structure to said left one of said pivotally connected sides, and/or from said second base structure to said right one of said pivotally connected sides.

12. The system of claim 11 wherein said telescoping connectors are responsive to control signals received from a controller and capable of locking into a desired position in response thereto, thereby selectively inhibiting shear deformation in a desired configuration.

13. The system of claim 12 wherein said each of said one or more telescoping connectors include one or more actuators responsive to said control signals from said controller.

14. The system of claim 3 wherein said airfoil includes a frame having one or more adjustable spars connected to one or more adjustable ribs and a deformable surface substantially covering said frame or a portion thereof.

15. The system of claim 14 wherein said spars and ribs are interconnected so that selectively expanding or contracting a cord of said airfoil automatically sweeps said airfoil back or forward an edge of said air foil.

16. A system for selectively resisting torsion deformation within a transformable airfoil comprising:
a bellows device having an adjustable configuration, said bellows device adapted to resist torsion about a longitudinal axis of said bellows device and
base sections fixed to said bellows device and to said transformable airfoil or a ftrame thereof so that actuation of said transformable airfoil causes said bellows device to exhibit elastic shear deformation.

17. The system of claim 16 wherein said airfoil includes a frame having one or more adjustable spars or ribs and a deformable surface substantially covering said frame or a portion thereof, said one or more adjustable spars or ribs sufficient to enable changes in sweep angle and area of said airfoil.

18. A system for selectively resisting torsion deformation comprising:
a bellows device having an adjustable configuration, said bellows device adapted to resist torsion about a longitudinal axis of said bellows device and
first means for altering said configuration to selectively enable said bellows device to deform in shear and to resist deformation in shear to a desired degree.

19. The system of claim 18 wherein said bellows device has a first base at a first end and a second base at a second end.

20. The system of claim 19 further including a support connector pivotally mounted to said first base at a first pivot connector and to a side panel adjacent to said bellows device at a second connector, and wherein said first means includes a controller for providing control signals to said support connector, said control signals sufficient to selectively extend, contract, or lock said support connector into a desired position to resist torsion deformation and to selectively enable shear deformation.

21. A structural support for a transformable airfoil comprising:
a bellows structure adapted to resist torsion deformation but enable strain and/or shear deformation and
means for mounting said bellows structure within said transformable airfoil.

22. The structural support of claim 21 wherein said means for mounting includes a wing box structure that includes first base structure attached to one end of said bellows structure and a second base structure attached to another end of said base structure.

24. A method for controlling deformation of a structure comprising the step of:
employing a bellows device positioned on or within said structure to resist deformation about an axis of said structure while selectively enabling deformation along an axis of said bellows device and/or at an angle to said axis.

25. The method of claim 24 further comprising the step of positioning said bellows device within a transformable wing.
